(19) United States
(12) Patent Application Publication
(10) Pub. No.: US 2011/0159195 A1
(43) Pub. Date: Jun. 30, 2011

(54) PRESSURE-SENSITIVE ADHESIVE COMPOSITION, PRESSURE-SENSITIVE ADHESIVE SHEET AND METHOD FOR PRODUCING PRESSURE-SENSITIVE ADHESIVE SHEET

(75) Inventors: Masahito NIWA, Osaka (JP); Masayuki OKAMOTO, Osaka (JP); Chie KITANO, Osaka (JP)

(73) Assignee: NITTO DENKO CORPORATION, Osaka (JP)

(21) Appl. No.: 12/975,453

(22) Filed: Dec. 22, 2010

(30) Foreign Application Priority Data
Dec. 25, 2009 (JP) 2009-294490

(51) Int. Cl. C08F 226/06; C08F 220/18; C08F 226/10; C08F 220/68; B05D 3/02

(52) U.S. Cl. 427/385.5; 526/258; 526/263; 526/264

(57) ABSTRACT

The present invention relates to an acrylic pressure-sensitive adhesive composition comprising a copolymerization reaction product of a monomer mixture satisfying the following both conditions: (a) the monomer mixture includes a monomer m1 in an amount of 50% by mass or more based on whole monomer components constituting the monomer mixture, wherein the monomer m1 is an alkyl (meth)acrylate represented by the following formula (I):

CH₂═C(R¹)COOR² (I)

wherein R¹ represents a hydrogen atom or a methyl group, and R² represents an alkyl group having from 1 to 20 carbon atoms; and (b) the monomer mixture includes a monomer m2 in an amount of 12% by mass or more based on the whole monomer components constituting the monomer mixture, or a monomer m2 and a monomer m3 in an amount in total of 12% by mass or more based on the whole monomer components constituting the monomer mixture, wherein the monomer m2 is an imidazole group-containing unsaturated monomer, and the monomer m3 is an amide group-containing unsaturated monomer.

### FIELD OF THE INVENTION

The present invention relates to an acrylic pressure-sensitive adhesive composition, a pressure-sensitive adhesive sheet and a method for producing a pressure-sensitive adhesive sheet.

### BACKGROUND OF THE INVENTION

In recent years, pressure-sensitive adhesive sheets have come to be used in various applications such as fixing (joining), conveyance, protection and decoration of goods. Representative examples of such a pressure-sensitive adhesive sheet include those provided with a pressure-sensitive adhesive layer formed using an acrylic pressure-sensitive adhesive composition. Typically, such an acrylic pressure-sensitive adhesive composition is constituted such that the acrylic pressure-sensitive adhesive composition can form a pressure-sensitive adhesive layer containing an acrylic polymer as a base polymer. As conventional technical documents related to the acrylic pressure-sensitive adhesive composition, there are exemplified Patent Documents 1 and 2.
Patent Document 1: JP-A-2007-153913
Patent Document 2: JP-A-2008-222953

### SUMMARY OF THE INVENTION

In the case where goods such as members having a joint by a pressure-sensitive adhesive sheet (typically a pressure-sensitive adhesive sheet having a double-sided adhesiveness) are held under high temperature environment (for example, 80° C. or higher) over a long period of time, it is desirable that the pressure-sensitive adhesive sheet to be used is provided with a pressure-sensitive adhesive layer having a high cohesive property such that peeling on the joint does not occur even under such a high temperature environment. In particular, in the case where the joint is held under high temperature environment and under a certain load (load in a shear direction) over a long period of time, high cohesive property is required. Meanwhile, when the cohesive property is increased, in general, tackiness (stickiness) is lowered, so that an adhesive force under low temperature environment tends to become insufficient. However, in the case where the foregoing members would be placed in a wide-ranging temperature region of from low temperature to high temperature (for example, the case where an adherend is a member included in a vehicle or the like), both excellent high-temperature holding force (cohesive property under high temperature loading environment) and favorable low-temperature adhesiveness (adhesiveness under low temperature environment) are required at the same time.

An object of the invention is to provide an acrylic pressure-sensitive adhesive composition capable of forming a pressure-sensitive adhesive layer, in which both excellent high-temperature holding properties and favorable low-temperature adhesiveness are simultaneously realized with a good balance. Also, another object of the invention is to provide a pressure-sensitive adhesive sheet using such a composition. In addition, another object of the invention is to provide a method for producing such a pressure-sensitive adhesive sheet.

That is, the present invention relates to the following an acrylic pressure-sensitive adhesive compositions, pressure-sensitive adhesive sheets, and a method for producing a pressure-sensitive adhesive sheet.

(1) An acrylic pressure-sensitive adhesive composition comprising a copolymerization reaction product of a monomer mixture satisfying the following both conditions:

(a) the monomer mixture includes a monomer m1 in an amount of 50% by mass or more based on whole monomer components constituting the monomer mixture,

wherein the monomer m1 is an alkyl (meth)acrylate represented by the following formula (I):

CH₂═C(R¹)COOR² (I)

wherein R¹ represents a hydrogen atom or a methyl group, and R² represents an alkyl group having from 1 to 20 carbon atoms; and

(b) the monomer mixture includes a monomer m2 in an amount of 12% by mass or more based on the whole monomer components constituting the monomer mixture, or a monomer m2 and a monomer m3 in an amount in total of 12% by mass or more based on the whole monomer components constituting the monomer mixture,

wherein the monomer m2 is an imidazole group-containing unsaturated monomer, and

the monomer m3 is an amide group-containing unsaturated monomer.

(2) The pressure-sensitive adhesive composition according to the above (1),

wherein the monomer mixture includes the monomer m2 in an amount of 12% by mass or more based on the whole monomer components constituting the monomer mixture.

(3) The pressure-sensitive adhesive composition according to above (1) or (2), wherein the monomer mixture includes the monomer m3 in an amount of 0.1% by mass or more based on the whole monomer components constituting the monomer mixture.

(4) The pressure-sensitive adhesive composition according to any one of the above (1) to (3), wherein the monomer m2 is 1-vinylimidazole.

(5) The pressure-sensitive adhesive composition according to any one of the above (1) to (4), wherein the monomer m3 is an N-vinyl cyclic amide compound represented by the following formula (II):

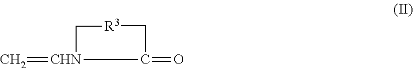

wherein R³ represents a divalent organic group having a number of atoms included in a lactam ring of from 3 to 5.

(6) The pressure-sensitive adhesive composition according to the above (5), wherein the N-vinyl cyclic amide compound is N-vinyl-2-pyrrolidone.

(7) The pressure-sensitive adhesive composition according to any one of the above (1) to (6), wherein a blending ratio of the monomer m2 to the monomer m3 is from 10/1 to 1/10.

(8) The pressure-sensitive adhesive composition according to any one of the above (1) to (7), which further comprises a crosslinking agent.

(9) A pressure-sensitive adhesive sheet comprising a pressure-sensitive adhesive layer formed of the pressure-sensitive adhesive composition according to any one of the above (1) to (8).

(10) A method for producing a pressure-sensitive adhesive sheet, the method comprising:

(X) subjecting a monomer mixture to a copolymerization reaction to prepare a pressure-sensitive adhesive composition, wherein the monomer mixture satisfying the following both conditions:

(a) the monomer mixture includes a monomer m1 in an amount of 50% by mass or more based on the whole monomer components constituting the monomer mixture,

wherein the monomer m1 is an alkyl (meth)acrylate represented by the following formula (I):

CH₂═C(R¹)COOR² (I)

wherein R¹ represents a hydrogen atom or a methyl group, and R² represents an alkyl group having from 1 to 20 carbon atoms; and

(b) the monomer mixture includes a monomer m2 in an amount of 12% by mass or more based on the whole monomer components constituting the monomer mixture, or a monomer m2 and a monomer m3 in an amount in total of 12% by mass or more based on the whole monomer components constituting the monomer mixture,

wherein the monomer m2 is an imidazole group-containing unsaturated monomer, and

the monomer m3 is an amide group-containing unsaturated monomer;

(Y) applying the pressure-sensitive adhesive composition on a base material; and

(Z) curing the coated pressure-sensitive adhesive composition to form a pressure-sensitive adhesive layer.

The pressure-sensitive adhesive composition provided in the present invention includes at least a copolymerization reaction product of a monomer mixture. The monomer mixture includes an alkyl (meth)acrylate represented by the following formula (I):

CH₂═C(R¹)COOR² (I)

(wherein R¹ represents a hydrogen atom or a methyl group, and R² represents an alkyl group having from 1 to 20 carbon atoms) as a monomer m1, and an imidazole group-containing unsaturated monomer as a monomer m2. This monomer mixture may further optionally include an amide group-containing unsaturated monomer as a monomer m3. An amount of the monomer m1 included in the monomer mixture is 50% by mass or more based on the whole monomer components constituting the monomer mixture. Also, an amount of the monomer m2, or a total amount of the monomers m2 and m3, is 12% by mass or more based on the whole monomer components constituting the monomer mixture. The copolymerization reaction product may be either a completely polymerized material or a partially polymerized material of the monomer mixture. The completely polymerized material as referred to in this specification means a resultant obtained by a substantially complete copolymerization reaction of the monomer mixture (namely, copolymerization reaction of substantially the whole monomer components constituting the monomer mixture). Also, the partially polymerized material as referred to in this specification means a resultant obtained by a copolymerization reaction of a part of the monomer mixture. Typically, the partially polymerized material includes a polymer obtained by partial copolymerization of the monomer included in the monomer mixture (inclusive of polymers having a relatively low degree of polymerization; for example, a polymer having a mass average molecular weight of approximately not more than 1×10⁴ (sometimes also referred to as “oligomer”) may be included); and unreacted monomers. The foregoing copolymerization reaction product may include, in addition to the foregoing monomers and/or copolymers thereof, other components used for the copolymerization reaction (for example, a polymerization initiator, a solvent, and a dispersion medium). The unsaturated monomer as referred to herein means a monomer having an ethylenically unsaturated group such as a vinyl group, an allyl group and a (meth)acryloyl group.

According to the pressure-sensitive adhesive composition having such a composition, since the pressure-sensitive adhesive composition includes at least the partially polymerized material of the monomer mixture including a prescribed amount of the monomer m2 or a combination of the monomers m2 and m3, in addition to the monomer m1 as a main monomer (main monomer component means a monomer accounting for 50% by mass or more based on the whole monomer components constituting the monomer mixture), a pressure-sensitive adhesive layer having both excellent high-temperature holding properties and favorable low-temperature adhesiveness can be formed. The pressure-sensitive adhesive layer can be, for example, formed by applying (coating) the pressure-sensitive adhesive composition onto a base material and then optionally properly subjecting to a processing treatment to cure the pressure-sensitive adhesive composition.

As a suitable example of the monomer m2, 1-vinylimidazole is exemplified. Also, an N-vinyl cyclic amide compound represented by the following formula (II) is preferably used as the monomer m3.

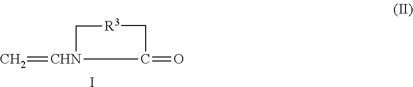

n the formula (II), R³ represents a divalent organic group. The N-vinyl cyclic amide compound is especially preferably N-vinyl-2-pyrrolidone.

In an embodiment of the pressure-sensitive adhesive composition as disclosed herein, the monomer mixture includes the monomer m2 in a proportion of 12% by mass or more based on the whole monomer components constituting the monomer mixture. In another embodiment, the monomer mixture includes the monomer m3 in a proportion of 0.1% by mass or more based on the whole monomer components constituting the monomer mixture.

In another embodiment, the pressure-sensitive adhesive composition further includes a crosslinking agent. According to such a pressure-sensitive adhesive composition, a pressure-sensitive adhesive (may be a pressure-sensitive adhesive layer of a pressure-sensitive adhesive sheet; hereinafter the same) with a more excellent balance in pressure-sensitive adhesive performances (for example, high-temperature holding force, and low-temperature adhesiveness) can be realized.

From another viewpoint, according to the invention, a pressure-sensitive adhesive sheet provided with a pressure-sensitive adhesive layer formed of any one of the pressure-sensitive adhesive composition as disclosed herein is provided. Typically, this pressure-sensitive adhesive sheet is provided with such a pressure-sensitive adhesive layer on at least one surface of a base material. The base material is one for supporting the pressure-sensitive adhesive layer and may be a non-releasing base material, a release liner or the like. Such a pressure-sensitive adhesive sheet can simultaneously realize both excellent high-temperature holding properties and low-temperature adhesiveness.

Furthermore, from a still other viewpoint, according to the invention, a method for producing a pressure-sensitive adhesive sheet is provided. This method includes the steps of:

(X) subjecting a monomer mixture to a copolymerization reaction to prepare a pressure-sensitive adhesive composition;

(Y) applying the pressure-sensitive adhesive composition on a base material; and

(Z) curing the coated pressure-sensitive adhesive composition to form a pressure-sensitive adhesive layer.

The monomer mixture includes (a) an alkyl (meth)acrylate represented by the following formula (I): CH₂═C(R¹)COOR² (wherein R¹ represents a hydrogen atom or a methyl group, and R² represents an alkyl group having from 1 to 20 carbon atoms). The monomer mixture further includes (b) a monomer m2 in an amount of 12% by mass or more based on the whole monomer components constituting the monomer mixture, or a monomer m2 and a monomer m3 in an amount in total of 12% by mass or more based on the whole monomer components constituting the monomer mixture.

In the foregoing step (X), the copolymerization reaction may be performed only in an early stage where a large amount of unreacted monomers remain (namely, the copolymerization reaction is partially performed), or may be performed to an extent of a final stage where unreacted monomers do not substantially remain (namely, the copolymerization reaction is substantially completely performed). Removal or addition of a solvent, addition of a crosslinking agent or the like may be performed as the need arises. In the foregoing step (Z), the curing treatment after coating the composition may be drying (heating), crosslinking, additional copolymerization reaction, aging or the like. These processing treatments may be performed singly or in combinations of two or more kinds thereof. Two or more kinds of processing treatments (for example, crosslinking and drying) may be performed simultaneously or over multiple stages. For example, a treatment of merely performing drying (heat treatment, etc.) is also included in the curing treatment as referred to herein. According to such a method, a pressure-sensitive adhesive sheet which is excellent in high-temperature holding force and low-temperature adhesiveness can be efficiently produced.

### BRIEF DESCRIPTION OF DRAWINGS

FIG. 1 is a sectional view schematically showing a configuration example of a pressure-sensitive adhesive sheet according to the invention.

FIG. 2 is a sectional view schematically showing another configuration example of a pressure-sensitive adhesive sheet according to the invention.

FIG. 3 is a sectional view schematically showing another configuration example of a pressure-sensitive adhesive sheet according to the invention.

FIG. 4 is a sectional view schematically showing another configuration example of a pressure-sensitive adhesive sheet according to the invention.

FIG. 5 is a sectional view schematically showing another configuration example of a pressure-sensitive adhesive sheet according to the invention.

FIG. 6 is a sectional view schematically showing another configuration example of a pressure-sensitive adhesive sheet according to the invention.

### DESCRIPTION OF REFERENCE NUMERALS AND SIGNS

1: Base material
2: Pressure-sensitive adhesive layer
3: Release liner
11, 12, 13, 14, 15, 16: Pressure-sensitive adhesive sheet

### DETAILED DESCRIPTION OF THE INVENTION

Preferred embodiments of the invention are hereunder described. The matters which are other than those specifically indicated in this specification and are necessary in carrying out the invention may be grasped as a matter of design variation by those skilled in the art on the basis of conventional technologies in the subject technical field. The invention can be carried out on the basis of the contents disclosed in this specification and common general technical knowledge in the subject technical field.

The pressure-sensitive adhesive composition as disclosed herein includes a copolymerization reaction product of a monomer mixture including at least monomers m1 and m2 as essential components. The monomer mixture may optionally include a monomer m3.

The monomer m1 is at least one kind of alkyl (meth)acrylates ((meth)acrylic acid esters of alkyl alcohols) represented by the following formula (I). The term “(meth)acrylic acid” as referred to herein is a concept including acrylic acid and methacrylic acid.

CH₂═C(R¹)COOR² (I)

Here in the formula (I), R¹ represents a hydrogen atom or a methyl group. Also, in the formula (I), R² represents an alkyl group having from 1 to 20 carbon atoms. The alkyl group may be linear or branched. Specific examples of the alkyl (meth)acrylates represented by the formula (I) include methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, t-butyl (meth)acrylate, pentyl (meth)acrylate, isopentyl (meth)acrylate, hexyl (meth)acrylate, heptyl (meth)acrylate, n-octyl (meth)acrylate, isooctyl (meth)acrylate, 2-ethylhexyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate and eicosyl (meth)acrylate. Among them, alkyl (meth)acrylates in which R² is an alkyl group having from 2 to 14 carbon atoms (such a range of carbon atom number will be hereinafter sometimes referred to as “C₂₋₁₄”) are preferable, and alkyl (meth)acrylates in which R² is a C₂₋₁₀ alkyl group (for example, an n-butyl group, and a 2-ethylhexyl group) are more preferable.

In a preferred embodiment of the present invention, about 70% by mass or more (more preferably about 90% by mass or more) of the total amount of the monomer m1 is occupied by the alkyl (meth)acrylate represented by the formula (I) wherein R² is a C₂₋₁₀ alkyl group (more preferably a C₄₋₃ alkyl group). Substantially the whole of the monomer m1 may be occupied by the alkyl (meth)acrylate represented by the formula (I) wherein R² is a C₂₋₁₀ alkyl group (more preferably a C₄₋₈ alkyl group). The monomer mixture may be, for example, a composition including n-butyl acrylate (BA) alone, a composition including 2-ethylhexyl acrylate (2EHA) alone, a composition including two kinds of BA and 2EHA as the monomer m1.

An amount of the monomer nil included in the monomer mixture (in the case of including two or more kinds of alkyl (meth)acrylates, a total amount thereof) may be from about 50% to 88% by mass (preferably from about 60% to 85% by mass) based on the whole monomer components constituting the monomer mixture. In the pressure-sensitive adhesive composition, when the content of the monomer m1 is excessively small as compared with the foregoing range, there may be the case where pressure-sensitive adhesive performances (tackiness, especially low-temperature adhesiveness) of the pressure-sensitive adhesive layer formed from the composition tend to become insufficient. When the content of the monomer m1 is excessively large as compared with the foregoing range, since the amount of the monomer m2, or the total amount of the monomers m2 and m3, which may be included in the monomer mixture becomes small, there may be the case where it is difficult to realize excellent high-temperature bolding properties and low-temperature adhesiveness with a good balance. Typically, the composition (monomer composition) of the monomer mixture is generally corresponding to a copolymerization proportion (copolymerization composition) of a copolymer obtained by copolymerizing the mixture.

The monomer mixture includes, in addition to the monomer m1, at least one kind of imidazole group-containing unsaturated monomers as the monomer m2. For example, imidazoles having an ethylenically unsaturated bond such as a vinyl group and an allyl group can be used. Examples of such unsaturated monomers include 1-vinylimidazole, 1-allylimidazole, 2-vinylimidazole, 1-vinyl-2-methylimidazole, 1-methyl-2-vinylimidazole, 1-methyl-5-vinylimidazole, 1-ethyl-5-vinylimidazole, 1-propyl-5-vinylimidazole, 1-butyl-5-vinylimidazole, 1-vinyl-2,4-dimethylimidazole, N-[2-(1H-imidazol-4-yl)ethyl]acrylamide, 1-vinylbenzimidazole, 2-vinylbenzimidazole, 1-vinyl-2-methylbenzimidazole, 4-[(1H-benzimidazol-2-yl)thiomethyl]styrene, N-[2,2,3-trichloro-1-(1H-imidazol-1-yl)propyl]acryl amide, N-[4-(1H-imidazol-4-yl)benzyl]acrylamide, N-(1H-benzimidazol-5-yl)acrylamide and 3-ethenyl-5,5-dimethyl-1H-imidazole-2,4(3H,5H)-dione. As the especially preferred monomer m2, 1-vinylimidazole is exemplified. These imidazole group-containing unsaturated monomers can be used singly or in combinations of two or more kinds thereof.

The monomer m2 may function as a component capable of contributing to an enhancement of cohesive property of the pressure-sensitive adhesive due to an intermolecular interaction. When the monomer m3 as described later is not used, an amount of the monomer m2 included in the monomer mixture is about 12% by mass or more (preferably 15% by mass or more, and more preferably 20% by mass or more) based on the whole monomer components constituting the monomer mixture. When the amount of the monomer m2 is too small, there may be the case where low-temperature adhesiveness and durability against peeling in the presence of a certain load tend to become insufficient. An upper limit of the content of the monomer m2 can be, for example, about 40% by mass (preferably 35% by mass, and more preferably 30% by mass) based on the whole monomer components constituting the monomer mixture. When the amount of the monomer m2 is too large, there may be the case where sufficient tackiness or low-temperature adhesiveness is not realized.

The monomer mixture may include the monomer m3 as an optional component. At least one kind of amide group-containing unsaturated monomers are used as the monomer m3. For example, the amide group-containing unsaturated monomer may be at least one kind of monomers selected from N-vinyl cyclic amide compounds and (meth)acrylamide compounds which may have an N-alkyl group. Specific examples of the N-vinyl cyclic amide compounds include N-vinyl-2-pyrrolidone, N-vinyl-2-piperidone, N-vinyl-3-morpholinone, N-vinyl-2-caprolactam, N-vinyl-1,3-oxazin-2-one and N-vinyl-3,5-morpholinedione. Specific examples of the (meth)acrylamide compounds which may have an N-alkyl group include (meth)acrylamide; N-alkyl(meth)acrylamides such as N-ethyl(meth)acrylamide, N-n-butyl(meth)acrylamide and N-octyl(meth)acrylamide; N,N-dialkyl(meth)acrylamides such as N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide and N,N-di(t-butyl)(meth)acrylamide; and aminoalkyl group-containing (meth)acrylamides such as dimethylaminoethyl(meth)acrylamide and diethylaminoethyl(meth)acrylamide.

Examples of other amide group-containing unsaturated monomers include N-(meth)acryloyl group-containing heterocyclic compounds such as N-(meth)acryloyl morpholine, N-(meth)acryloyl pyrrolidone and N-(meth)acryloyl pyrrolidine.

The amide group-containing unsaturated monomer is especially preferably an N-vinyl cyclic amide compounds (N-vinyl lactams) represented by the following formula (II).

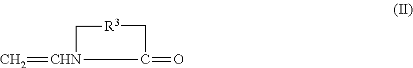

Here, R³ represents a divalent organic group having a number of atoms included in a lactam ring of from 3 to 5. In the formula (II), R³ is preferably a saturated or unsaturated divalent hydrocarbon group, and more preferably a saturated divalent hydrocarbon group (for example, an alkylene group having 3 or 4 carbon atoms). According to the monomer mixture having such a composition, a pressure-sensitive adhesive layer with a more excellent balance in pressure-sensitive adhesive characteristics may be realized. As a suitable example of the N-vinyl cyclic amide compounds, N-vinyl-2-pyrrolidone is exemplified.

By using the monomer m3 in combination with the monomer m2, the monomer m3 may function as a component capable of contributing to an enhancement of cohesive property of the pressure-sensitive adhesive. In the case of using the monomer m3, an amount of the monomer m3 included in the monomer mixture can be properly chosen depending upon the content of the monomer m2 such that a total amount of the monomers m2 and m3 is about 12% by mass or more (preferably 15% by mass or more, and more preferably 20% by mass or more) based on the whole monomer components constituting the monomer mixture. For example, the amount of the monomer m3 may be chosen to be 0.1% by mass or more based on the whole monomer components constituting the monomer mixture such that the total amount of the monomers m2 and m3 falls within the foregoing range. In the case of using the monomer m3, when the total amount of the monomers m2 and m3 is too small, there may be the case where low-temperature adhesiveness and durability against peeling in the presence of a certain load tend to become insufficient. Similar to the case where the monomer m3 is not used, an upper limit of the total amount of the monomers m2 and m3 can be, for example, about 40% by mass (preferably 35% by mass, and more preferably 30% by mass) based on the whole monomer components constituting the monomer mixture. When the total amount of the monomers m2 and m3 is too large, there may be the case where sufficient tackiness or low-temperature adhesiveness is not realized. A blending ratio of the monomer m2 to the monomer m3 (m2/m3) is preferably from about 10/1 to 1/10 (more preferably from about 5/1 to 1/5).

A total amount of the monomers m1 and m2, or the monomers m1, m2 and m3, included in the monomer mixture may be, for example, about 70% by mass or more based on the whole monomer components constituting the monomer mixture. The foregoing total amount is preferably about 80% by mass or more (for example, 90% by mass or more) based on the whole monomer components constituting the monomer mixture.

The monomer mixture may include, in addition to the monomers m1, m2 and m3, a monomer m4 as other optional component. The monomer m4 may be at least one kind of monomers other than the monomers corresponding to the monomers m1, m2 and m3. For example, various monomers having at least one ethylenically unsaturated group such as a (meth)acryloyl group and a vinyl group can be used.

The monomer m4 may be a nitrogen atom-containing monomer other than the monomers corresponding to the monomers m2 and m3 (namely, those other than the imidazoles and the acrylamide compounds). Examples of the monomer m4 include amino group-containing (meth)acrylates such as aminoethyl (meth)acrylate, N,N-dimethylaminoethyl (meth)acrylate and N,N-dimethylaminopropyl (meth)acrylate; nitrogen atom-containing heterocyclic compounds having vinyl group such as N-vinylpyridine, N-vinylpyrimidine, N-vinylpiperazine and N-vinylpyrrole; and cyano acrylates such as acrylonitrile and methacrylonitrile. Also, there are exemplified imide group-containing monomers such as maleimide based monomers, for example, N-cyclohexyl maleimide and N-phenyl maleimide; itaconimide based monomers, for example, N-methylitaconimide, N-ethylitaeonimide, N-butylitaconimide, N-2-ethylhexylitaconimide, N-laurylitaconimide and N-cyclohexylitaconimide; and succinimide based monomers, for example, N-(meth)acryloxy methylene succinimide, N-(meth)acryloyl-6-oxyhexamethylene succinimide and N-(meth)acryloyl-8-oxyhexamethylene succinimide.

Other examples of the monomer m4 include various (meth)acrylates such as alicyclic hydrocarbon group-containing (meth)acrylates, for example, cyclopentyl (meth)acrylate, cyclohexyl (meth)acrylate, bornyl (meth)acrylate and isobornyl (meth)acrylate; aromatic hydrocarbon group-containing (meth)acrylates, for example, phenyl (meth)acrylate and benzyl (meth)acrylate; alkyl (meth)acrylates represented by the formula (I) wherein R² is an alkyl group having 21 or more carbon atoms; and hydroxyalkyl (meth)acrylates, for example, 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and [4-(hydroxymethyl)cyclohexyl]methyl (meth)acrylate.

Furthermore, other examples of the monomer m4 include carboxyl group-containing monomers such as vinyl ester based monomers, for example, vinyl acetate and vinyl propionate; ethylenically unsaturated monocarboxylic acids, for example, acrylic acid, methacrylic acid and crotonic acid; and ethylenically unsaturated carboxylic acid anhydrides, for example, maleic anhydride and itaconic anhydride.

A content of the monomer m4 (in the case of including two or more kinds of monomers, a total content thereof) is suitably not more than about 30% by mass based on the whole monomer components constituting the monomer mixture. The content of the monomer m4 is preferably not more than about 10% by mass, and more preferably not more than about 5% by mass (for example, not more than about 2% by mass) based on the whole monomer components constituting the monomer mixture. Alternatively, a monomer mixture which does not substantially contain the monomer m4 may be used. When the content of the monomer m4 is too large, there may be the case where in a pressure-sensitive adhesive sheet formed using the subject pressure-sensitive adhesive composition, desired high-temperature holding properties and/or low-temperature adhesiveness is not realized.

In a preferred embodiment of the present invention, among the monomer m4, a use amount of the carboxyl group-containing monomer is regulated to not more than 10% by mass. Alternatively, the monomer mixture may be a composition which does not substantially include the carboxyl group-containing monomers. In the pressure-sensitive adhesive composition as disclosed herein, owing to the use of the monomer m2 (or the monomers m2 and m3), even when an ethylenically unsaturated carboxylic acid such as acrylic acid and methacrylic acid is not used, sufficient cohesive property is obtainable. In this way, what the use of an ethylenically unsaturated carboxylic may be omitted is advantageous from the viewpoint of an enhancement in low-temperature adhesiveness. Also, such is preferable from the viewpoint of a reduction in metal corrosion.

The pressure-sensitive adhesive composition as disclosed herein includes at least a copolymerization reaction product of the monomer mixture. A copolymerization method of the monomer mixture is not particularly limited, and various polymerization methods which are conventionally known can be properly adopted. For example, polymerization methods of performing the polymerization using a thermal polymerization initiator (thermal polymerizations such as solution polymerization, emulsion polymerization and bulk polymerization); photopolymerization methods of performing the polymerization upon irradiation with light (for example, ultraviolet rays) in the presence of a photopolymerization initiator; radiation polymerization methods of performing the polymerization upon irradiation with high energy rays such as radiations (for example, β-rays, and γ-rays) in order to generate a radical, a cation, an anion, etc.; and so on can be properly adopted.

A polymerization embodiment is not particularly limited, and the polymerization can be performed by properly choosing a conventionally known monomer feeding method, a polymerization condition (for example, temperature, time, and pressure) or a use component other than the monomers (for example, polymerization initiators and surfactants). For example, as the monomer feeding method, a mixture of the whole of monomers may be fed into a reaction vessel at once (batch feeding), or may be fed by gradual dropwise addition (continuous feeding). Alternatively, the monomer mixture may be divided several times, thereby feeding each divided amount thereof at prescribed intervals (divided feeding). The monomer mixture may also be fed as a solution prepared by dissolving a part or the whole of the monomer mixture in a solvent, or a dispersion prepared by emulsifying a part or the whole of the monomer mixture in water together with an appropriate emulsifier.

As the polymerization initiator which is used for performing the copolymerization reaction, at least one member properly selected among known or customary polymerization initiators can be used depending upon the polymerization method. For example, azo-based polymerization initiators, peroxide based initiators, redox based initiators including a combination of peroxides and reducing agents, substituted ethane based initiators and so on can be used for the thermal polymerizations (for example, solution polymerization, and emulsion polymerization). The thermal polymerization may be for example, carried out at temperature of from about 20° C. to 100° C. (typically from 40° C. to 80° C.). Various photopolymerization initiators can be used for the photopolymerizations.

Examples of the azo-based initiators include 2,2′-azobisisobutyronitrile (AIBN), 2,2′-azobis-2-methylbutyronitrile, dimethyl-2,2′-azobis(2-methylpropionate), 4,4′-azobis-4-cyanovaleric acid, azobisisovaleronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine) disulfate and 2,2′-azobis(N,N′-dimethyleneisobutylamidine) dihydrochloride.

Examples of the peroxide based initiators include persulfates such as potassium persulfate and ammonium persulfate, dibenzoyl peroxide, t-butyl permaleate, t-butyl hydroperoxide, di-t-butyl peroxide, t-butyl peroxybenzoate, dicumyl peroxide, 1,1-bis(t-butylperoxy)-3,3,5-trimethylcyclohexane, 1,1-bis(t-butylperoxy)cyclododecane and hydrogen peroxide.

Examples of the redox based initiators include a combination of a peroxide and ascorbic acid (for example, a combination of aqueous hydrogen peroxide and ascorbic acid), a combination of a peroxide and an iron(II) salt (for example, a combination of aqueous hydrogen peroxide and an iron(II) salt) and a combination of a persulfate and sodium hydrogensulfite.

Examples of the substituted ethane based initiators include phenyl-substituted ethane.

Examples of the photopolymerization initiators include ketal based photopolymerization initiators, acetophenone based photopolymerization initiators, benzoin ether based photopolymerization initiators, acyl phosphine oxide based photopolymerization initiators, α-ketol based photopolymerization initiators, aromatic sulfonyl chloride based photopolymerization initiators, photoactive oxime based photopolymerization initiators, benzoin based photopolymerization initiators, benzil based photopolymerization initiators, benzophenone based photopolymerization initiators and thioxanthone based photopolymerization initiators.

Specific examples of the ketal based photopolymerization initiators include 2,2-dimethoxy-1,2-diphenylethan-1-one [for example, trade name “Irgacure 651” (manufactured by Ciba Japan K.K.)].

Specific examples of the acetophenone based photopolymerization initiators include 1-hydroxycyclohexyl phenyl ketone [for example, trade name “Irgacure 184” (manufactured by Ciba Japan K.K.)], 2,2-diethoxyacetophenone, 2,2-dimethoxy-2-phenylacetophenone, 4-phenoxydichloroacetophenone and 4-(t-butyl)dichloroacetophenone.

Specific examples of the benzoin ether based photopolymerization initiators include benzoin methyl ether, benzoin ethyl ether, benzoin propyl ether, benzoin isopropyl ether and benzoin isobutyl ether.

As the acyl phosphine oxide based photopolymerization initiators, for example, trade name “Lucirin TPO” (manufactured by BASF SE) and so on can be used.

Specific examples of the α-ketol based photopolymerization initiators include 2-methyl-2-hydroxypropiophenone and 1-[4-(2-hydroxyethyl)phenyl]-2-methylpropan-1-one.

Specific examples of the aromatic sulfonyl chloride based photopolymerization initiators include 2-naphthalenesulfonyl chloride.

Specific examples of the photoactive oxime based photopolymerization initiators include 1-phenyl-1,1-propanedione-2-(o-ethoxycarbonyl)-oxime.

Specific examples of the benzoin based photopolymerization initiators include benzoin.

Specific examples of the benzil based photopolymerization initiators include benzil.

Specific examples of the benzophenone based photopolymerization initiators include benzophenone, benzoylbenzoic acid, 3,3″-dimethyl-4-methoxybenzophenone, polyvinylbenzophenone and α-hydroxycyclohexyl phenyl ketone.

Specific examples of the thioxanthone based photopolymerization initiators include thioxanthone, 2-chlorothioxanthone, 2-methylthioxanthone, 2,4-dimethylthioxanthone, isopropylthioxanthone, 2,4-diisopropylthioxanthone and dodecylthioxanthone.

A use amount of the polymerization initiator may be a usual use amount, and it can be, for example, chosen within the range of from about 0.001 parts to 5 parts by mass (typically from about 0.01 parts to 2 parts by mass, for example, from about 0.01 parts to 1 part by mass) based on 100 parts by mass of the whole monomer components constituting the monomer mixture. When the use amount of the polymerization initiator is too large or too small, there may be the case where desired pressure-sensitive adhesive performances are hardly obtainable.

As the emulsifiers (surfactants) which are used for the emulsion polymerization, anionic emulsifiers, nonionic emulsifiers and so on can be used. Examples of the anionic emulsifiers include a polyoxyethylene alkyl ether sodium sulfate, a polyoxyethylene alkyl phenyl ether ammonium sulfate, a polyoxyethylene alkyl phenyl ether sodium sulfate, sodium lauryl sulfate, ammonium lauryl sulfate, sodium dodecylbenzene sulfonate and a sodium polyoxyethylene alkyl sulfosuccinate. Examples of the nonionic emulsifiers include a polyoxyethylene alkyl ether, a polyoxyethylene alkyl phenyl ether, a polyoxyethylene fatty acid ester and a polyoxyethylene polyoxypropylene block polymer. Also, radical polymerizable emulsifiers (reactive emulsifiers) having a structure in which a radical polymerizable group (for example, a vinyl group, a propenyl group, an isopropenyl group, a vinyl ether group (vinyloxy group), and an allyl ether group (allyloxy group)) is introduced into such an anionic or nonionic emulsifier may be used. Such an emulsifier can be used singly or in combinations of two or more kinds thereof. A use amount of the emulsifier (on the basis of a solids content) may be properly chosen, and it can be, for example, from about 0.2 parts to 10 parts by mass (preferably from about 0.5 parts to 5 parts by mass) based on 100 parts by mass of the whole monomer components constituting the monomer mixture.

The copolymerization reaction product included in the pressure-sensitive adhesive composition as disclosed herein is a resultant obtained by at least partially copolymerizing the monomer mixture. The copolymerization reaction product may be either a partially polymerized material or a completely polymerized material. That is, a polymerization rate of monomer (monomer conversion) in the copolymerization reaction product is not particularly limited, and the pressure-sensitive adhesive composition may include or may not substantially include unreacted monomers. Also, the pressure-sensitive adhesive composition may include other components used for the copolymerization reaction (which may be a polymerization initiator, a solvent, a dispersion medium or the like). In addition to the copolymerization reaction product, other components such as a polymerization initiator, a solvent and a dispersion medium may be further added to the pressure-sensitive adhesive composition as the need arises.

The polymerization rate of the copolymerization reaction product is determined by the following method.

### [Measurement of Polymerization Rate]

About 0.5 g of a sample is collected from the copolymerization reaction product, and a mass Wₚ₁ is precisely weighed. Subsequently, the sample is heated at 130° C. for 2 hours to evaporate the unreacted monomers, and a mass Wₚ₂ of the sample remaining after heating is precisely weighed. The polymerization rate is determined by substituting the respective values into the following expression.

Polymerization Rate(%)=(Wₚ₂/Wₚ₁)×100

In an embodiment of the present invention, the copolymerization reaction product may be for example, a partially polymerized material having a polymerization rate of from about 2% to 40% by mass (preferably from about 5% to 25% by mass). The partially polymerized material may be a syrup form in which a copolymer formed from a part of the monomer mixture and the unreacted monomers coexist. The partially polymerized material having such a condition is hereinafter sometimes referred to as “monomer syrup”. A polymerization method of performing the partial polymerization of the monomer mixture is not particularly limited, and the foregoing various polymerization methods may be adopted. The pressure-sensitive adhesive composition of such an embodiment is constituted in such a manner that a pressure-sensitive adhesive can be formed by further curing (polymerizing) (typically, the pressure-sensitive adhesive composition is provided for an additional copolymerization reaction, thereby enhancing the polymerization rate to the same degree as in a completely polymerized material). A polymerization method for curing the composition is not particularly limited, and it may be the same as or different from the polymerization method adopted for the partial polymerization of the monomer mixture (the polymerization method on the occasion of preparing the composition). In view of the fact that the pressure-sensitive adhesive composition of such an embodiment is low in the polymerization rate and includes the unreacted monomers, even when the pressure-sensitive adhesive composition is not diluted with a solvent or a dispersion medium, the composition may have a viscosity to an extent that it can be coated. In consequence, such an embodiment is, for example, preferably applicable to a pressure-sensitive adhesive composition of a mode which does not substantially contain a solvent (non-solvent type). By constituting the non-solvent type pressure-sensitive adhesive composition in such a manner that it is curable by a polymerization method which does not require a solvent or a dispersion medium (for example, photopolymerization, and radiation polymerization), the pressure-sensitive adhesive layer can be formed by coating the composition onto an appropriate base material (which may also be a release liner) and subjecting it to a simple and easy curing treatment such as irradiation with light or irradiation with radiations. At that time, an appropriate crosslinking treatment or the like may be conducted as the need arises.

When the polymerization rate of the partially polymerized material is too high, there may be the case where handling properties of the composition are impaired depending upon the mode of the pressure-sensitive adhesive composition. For example, when the composition is a non-solvent type pressure-sensitive adhesive composition, there may be the case where the viscosity is too high, so that the coating becomes difficult at ordinary temperature. On the other hand, when the polymerization rate is too low, the characteristics of the pressure-sensitive adhesive obtained by curing the composition are easy to become instable, and there may be the case where the viscosity of the composition is too low, so that the coating becomes difficult.

The non-solvent type pressure-sensitive adhesive composition can be, for example, easily prepared by partially copolymerizing the monomer mixture by photopolymerization. Also, a material corresponding to the partially polymerized material obtained by photopolymerization may be prepared by other polymerization method than the photopolymerization, or by mixing a copolymer having a relatively low molecular weight obtained by partial polymerization by various polymerization methods and unreacted monomers. From the viewpoints of efficiency and simplicity, it is preferable to perform the partial polymerization of the monomer mixture by photopolymerization. According to the photopolymerization, the viscosity can be adjusted by changing an irradiation level of light to easily control the polymerization rate (monomer conversion) of the partially polymerized material. Also, in view of the fact that the obtained partially polymerized material already includes the photopolymerization initiator, on the occasion of further curing the composition to form a pressure-sensitive adhesive, the composition has a constitution such that it is photocurable as it is. At that time, a photopolymerization initiator may be additionally added as the need arises. The photopolymerization initiator to be additionally added may be the same as or different from the photopolymerization initiator used for the partial polymerization. The non-solvent type pressure-sensitive adhesive composition prepared by other method than the photopolymerization can be introduced photocurability by adding a photopolymerization initiator. The photocurable non-solvent type pressure-sensitive adhesive composition has such an advantage that a thick pressure-sensitive adhesive layer can be easily formed. Also, in view of the fact that an organic solvent is not used, such is preferable from the standpoint of environmental hygiene.

A use amount of the photopolymerization initiator is not particularly limited, and for example, the foregoing general use amount of the polymerization initiator can be properly adopted. The use amount of the photopolymerization initiator as referred to herein means a total amount of the photopolymerization initiators which are used in a production process of the pressure-sensitive adhesive composition. In consequence, in the pressure-sensitive adhesive composition obtained by additionally adding (post-adding) a photopolymerization initiator to the partially polymerized material obtained by photopolymerization, the use amount of the photopolymerization initiator means a total amount of the amount of the photopolymerization initiator used for the partial polymerization and the amount of the photopolymerization initiator additionally added.

In an embodiment of the present invention, the copolymerization reaction product is a completely polymerized material having a polymerization rate, as measured by the foregoing method, of about 95% by mass or more (preferably about 99% by mass or more). Such an embodiment is, for example, preferably applicable to a pressure-sensitive adhesive composition of a mode (for example, a solvent type (organic solvent solution state), an aqueous solution state, and an emulsion state) in which the pressure-sensitive adhesive component is diluted (dissolved or dispersed) with a solvent (for example, an organic solvent, water or a mixture thereof) to a suitable viscosity. By allowing the pressure-sensitive adhesive composition of such a mode to have an embodiment including a completely polymerized material, a pressure-sensitive adhesive layer can be formed by coating the composition onto an appropriate base material (which may also be a release liner) and subjecting it to a simple and easy curing treatment such as drying. At that time, an appropriate crosslinking treatment or the like may be conducted as the need arises.

The solvent type pressure-sensitive adhesive composition can be, for example, easily prepared by providing the monomer mixture for solution polymerization. According to the solution polymerization, the completely polymerized material may be efficiently formed. The solvent type pressure-sensitive adhesive composition can also be prepared by dissolving a copolymerization reaction product obtained by other polymerization method than the solution polymerization (typically a material corresponding to the completely polymerized material obtained by the solution polymerization) in an appropriate organic solvent. From the viewpoint of efficiency, the preparation by solution polymerization is preferable. The solvent type pressure-sensitive adhesive composition has such an advantage that a time required for the preparation or the curing treatment after coating is relatively short.

The pressure-sensitive adhesive composition in an emulsion state can be, for example, easily prepared by providing the monomer mixture for emulsion polymerization. According to the emulsion polymerization, the completely polymerized material may be efficiently formed. The pressure-sensitive adhesive composition in an emulsion state can also be prepared by emulsifying a copolymerization reaction product obtained by other polymerization method than the emulsion polymerization (typically a material corresponding to the completely polymerized material obtained by the emulsion polymerization) in an aqueous solvent (typically water) in the presence of an appropriate emulsifier. From the viewpoint of efficiency, the preparation by emulsion polymerization is preferable.

In a preferred embodiment of the present invention, the pressure-sensitive adhesive composition as disclosed herein contains a crosslinking agent. By using such a crosslinking agent, it is possible to impart appropriate cohesion and pressure-sensitive adhesive force to a pressure-sensitive adhesive layer formed from the subject composition. As the crosslinking agent, crosslinking agents which are conventionally known in the field of a pressure-sensitive adhesive can be properly chosen and used. For example, polyfunctional (meth)acrylates, isocyanate based crosslinking agents, epoxy based crosslinking agents, aziridine based crosslinking agents, melamine based crosslinking agents, metal chelate based crosslinking agents, metal salt based crosslinking agents, peroxide based crosslinking agents, oxazoline based crosslinking agents, urea based crosslinking agents, amino based crosslinking agents, carbodiimide based crosslinking agents, coupling agent based crosslinking agents (for example, silane coupling agents) and so on can be used. These materials may be used singly or in combinations of two or more kinds thereof. It is preferable that after the copolymerization reaction (complete polymerization or partial polymerization) of the monomer mixture, the crosslinking agent is added (namely, post-added).

In an embodiment in which the copolymerization reaction product is a partially polymerized material (typically, in the case of adopting photopolymerization), a polyfunctional (meth)acrylate (namely, a monomer having two or more (meth)acryloyl groups in one molecule thereof) can be preferably used as the crosslinking agent. Examples of the polyfunctional (meth)acrylate include trimethylolpropane tri(meth)acrylate, pentaerythritol tetra(meth)acrylate, 1,2-ethylene glycol di(meth)acrylate, 1,6-hexanediol di(meth)acrylate and dipentaerythritol hexaacrylate. From the viewpoints of polymerization reactivity (crosslinking reactivity) and so on, it is more preferable to use a polyfunctional acrylate. In a preferred embodiment, only at least one kind (typically one kind) of polyfunctional (meth)acrylates are used as the crosslinking agent. Alternatively, such a polyfunctional (meth)acrylate may be used in combination with other crosslinking agents (for example, isocyanate based crosslinking agents) within the range where the effects of the invention are not remarkably impaired. A use amount of the polyfunctional (meth)acrylate can be, for example, from about 0.001 parts to 5 parts by mass based on 100 parts by mass of the monomer mixture. Preferably, the use amount of the polyfunctional (meth)acrylate is suitably from about 0.01 parts to 3 parts by mass (for example, from about 0.05 parts to 0.5 parts by mass). For example, in the case of using a bifunctional (meth)acrylate, a larger quantity thereof may be properly chosen; whereas in the case of using a trifunctional (meth)acrylate, a smaller quantity thereof may be properly chosen. When the amount of the crosslinking agent is too small, there may be the case where a sufficient crosslinking effect is not exhibited, so that the cohesion (holding characteristic) tends to be lowered. On the other hand, when the amount of the crosslinking agent is too large, there may be the case where an elastic modulus of the pressure-sensitive adhesive after curing becomes excessively high, so that adhesive force or tackiness is easily lowered.

In an embodiment in which the copolymerization reaction product is a completely polymerized material (typically, in the case of adopting solution polymerization), epoxy based crosslinking agents, isocyanate based crosslinking agents and so on can be preferably used. In a preferred embodiment, only at least one kind (typically one kind) of epoxy based crosslinking agents, or only at least one kind (typically one kind) of isocyanate based crosslinking agents are used as the crosslinking agent. Alternatively, such a crosslinking agent may be used in combination with other various crosslinking agents within the range where the effects of the invention are not remarkably impaired.

Examples of the epoxy based crosslinking agents include epoxy based compounds having two or three or more epoxy groups in one molecule thereof, such as 1,3-bis(N,N-diglycidylaminomethyl)cyclohexane, N,N,N′X-tetraglycidyl-m-xylenediamine, diglycidylaniline, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, diglycidyl adipate, diglycidyl o-phthalate, triglycidyl-tris(2-hydroxyethyl)isocyanurate, resorcin diglycidyl ether, bisphenol S diglycidyl ether, 1,3-bis(N,N-diglycidylaminomethyl)benzene, 1,3-bis(N,N-diglycidylaminomethyl)toluene, isocyanurate, N,N,N′-tetraglycidyl-m-xylylenediamine, glycerin triglycidyl ether and trimethylolpropane glycidyl ether. Of these, for example, 1,3-bis(N,N-diglycidylaminomethyl)cyclohexane can be preferably used.

Examples of the isocyanate based crosslinking agents include isocyanate based compounds having two or three or more isocyanate groups in one molecule thereof, for example, aliphatic polyisocyanates such as 1,6-hexamethylene diisocyanate, 1,4-tetramethylene diisocyanate, 2-methyl-1,6-pentane diisocyanate, 3-methyl-1,5-pentane diisocyanate and lysine diisocyanate; alicyclic polyisocyanates such as isophorone diisocyanate, cyclohexyl diisocyanate, hydrogenated tolylene diisocyanate, hydrogenated xylene diisocyanate, hydrogenated diphenylmethane diisocyanate and hydrogenated tetramethylxylene diisocyanate; aromatic polyisocyanates such as 2,4-tolylene diisocyanate, 2,6-tolylene diisocyanate, 4,4′-diphenylmethane diisocyanate, 2,4′-diphenylmethane diisocyanate, 4 diphenyl ether diisocyanate, 2-nitrodiphenyl-4,4′-diisocyanate, 2,2′-diphenylpropane-4,4-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate and 3,3′-dimethoxydiphenyl-4,4′-diisocyanate; and aromatic aliphatic polyisocyanates such as xylylene-1,4-diisocyanate and xylylene-1,3-diisocyanate.

As the isocyanate based crosslinking agent, dimers, trimers, reaction products or polymers of the above-exemplified isocyanate based compounds (for example, a dimer or trimer of diphenylmethane diisocyanate, a reaction product between trimethylolpropane and tolylene diisocyanate, a reaction product between trimethylolpropane and hexamethylene diisocyanate, polymethylene polyphenyl isocyanate, polyether polyisocyanate and polyester polyisocyanate) and so on can be used. Of these, a reaction product between trimethylolpropane and tolylene diisocyanate can be preferably used.

A use amount of such a crosslinking agent in this embodiment can be, for example, from about 0.001 parts to 10 parts by mass (for example, from about 0.001 parts to 5 parts by mass) based on 100 parts by mass of the monomer mixture (in the case where the polymerization rate of the monomer mixture in the pressure-sensitive adhesive composition is approximately 100%, this value is generally corresponding to 100 parts by mass of the formed copolymer). The use amount of the crosslinking agent is preferably from about 0.01 parts to 5 parts by mass (for example, from 0.01 parts to 3 parts by mass). When the use amount of the crosslinking agent is too small, a sufficient effect (effect for enhancing the pressure-sensitive adhesive performances) is hardly exhibited, whereas when the use amount of the crosslinking agent is too large, a balance of the pressure-sensitive adhesive characteristics is easily broken.

In the pressure-sensitive adhesive layer to be provided in the pressure-sensitive adhesive sheet as disclosed herein, a gel fraction fg of the pressure-sensitive adhesive thereof is preferably from about 20% to 90%. In order that a pressure-sensitive adhesive having such a gel fraction (in the composition including a crosslinking agent, a pressure-sensitive adhesive after crosslinking) may be formed, it would be better to properly set up conditions such as monomer composition, polymerization rate of the monomer mixture in the pressure-sensitive adhesive composition, molecular weight of the copolymer to be formed, condition for forming the pressure-sensitive adhesive layer (for example, drying condition, and light irradiation condition) and kind and use amount of the crosslinking agent. When the gel fraction of the pressure-sensitive adhesive agent is too low, cohesion tends to become insufficient. On the other hand, when the gel fraction is too high, there may be the case where the adhesiveness or tackiness is easily lowered. According to the pressure-sensitive adhesive having a gel fraction in the range of from about 25% to 90% (for example, from about 60% to 85%), more favorable pressure-sensitive adhesive performances may be realized.

The “gel fraction fg of the pressure-sensitive adhesive” as referred to herein means a value measured by the following method. The gel fraction may be gasped as a mass proportion of an ethyl acetate-insoluble fraction of the pressure-sensitive adhesive. [Measurement Method of Gel Fraction]

A pressure-sensitive adhesive sample (mass Wₒ) is enclosed in a saccate form with a porous polytetrafluoroethylene film (mass W_{g2}) having an average pore size of 0.2 μm, and an opening is tied using a kite string (mass W_{g3}). This package is immersed in 50 mL of ethyl acetate and held at room temperature (typically 23° C.) for 7 days to elute only a sol component in the pressure-sensitive adhesive layer out of the film; the package is then taken out; ethyl acetate attached onto the outer surface is wiped off; the package is dried at 130° C. for 2 hours; and a weight of the package (mass W_{g4}) is measured. The gel fraction fg of the pressure-sensitive adhesive is determined by substituting the respective values into the following expression.

fg(%)=[(W_{g4}−W_{g2}−W_{g3})/W_{g1}]×100

It is desirable to use a film of its trade name “Nitofuron (registered trademark) NTF1122” (average pore size: 0.2 μm, porosity: 75%, thickness: 85 μm) which is available from Nitto Denko Corporation, or a corresponding material thereto, as the porous polytetrafluoroethylene (PTFE) film.

On the occasion of performing the copolymerization reaction of the monomer mixture, a chain transfer agent (which may also be grasped as a molecular weight modifier or a polymerization degree modifier) can be used as the need arises. As the chain transfer agent, at least one kind of known or customary chain transfer agents can be used. A use amount of the chain transfer agent may be a usual use amount, and it can be, for example, chosen within the range of from about 0.001 parts to 0.5 parts by mass based on 100 parts by mass of the monomer raw materials.

The pressure-sensitive adhesive composition as disclosed herein may include, as optional components, various additives which are general in the field of a pressure-sensitive adhesive composition. Examples of such optional components include tackifiers (for example, rosin based resins, petroleum based resins, terpene based resins, phenol based resins, and ketone based resins), plasticizers, softeners, fillers, colorants (for example, pigments, and dyes), antioxidants, leveling agents, stabilizers and antiseptics. As to such additives, conventionally known materials can be used by ordinary methods, and those additives do not particularly characterize the present invention. Therefore, their detailed explanations are omitted.

It is preferable that the pressure-sensitive adhesive composition as disclosed herein is constituted in such a manner that a final copolymer (corresponding to the acrylic copolymer included in the completely polymerized material) of the monomer mixture, which is included in the pressure-sensitive adhesive which is formed by a curing treatment (for example, drying, crosslinking, and polymerization) as the need arises, accounts for about 50% by mass or more (more preferably about 70% by mass or more, for example, 90% by mass or more). Such a pressure-sensitive adhesive composition may be a composition capable of forming a pressure-sensitive adhesive with more excellent pressure-sensitive adhesive performances.

The pressure-sensitive adhesive sheet according to the present invention is provided with a pressure-sensitive adhesive layer formed using any of the pressure-sensitive adhesive compositions as disclosed herein. The pressure-sensitive adhesive sheet according to the present invention may be a pressure-sensitive adhesive sheet in a mode in which such a pressure-sensitive adhesive layer is provided on one surface or both surfaces of a base material (support) in a sheet form in a fixed manner (without intending to separate the pressure-sensitive layer from the base material) (so-called base-provided pressure-sensitive adhesive sheet), or a pressure-sensitive adhesive sheet in a mode in which the pressure-sensitive adhesive layer is provided on a releasable support such as a release liner (for example, release paper, and a resin sheet whose surface is subjected to a release treatment) (a mode in which a base material for supporting the pressure-sensitive adhesive layer at the time of sticking is removed as a release liner) (so-called base-free pressure-sensitive adhesive sheet). A concept of the pressure-sensitive adhesive sheet as referred to herein may include those called a pressure-sensitive adhesive tape, a pressure-sensitive adhesive label, a pressure-sensitive adhesive film or the like. The pressure-sensitive adhesive layer is not limited to one continuously formed, but it may be a pressure-sensitive adhesive layer formed into a regular or random pattern in, for example, a spot-like form, a stripe-shaped form or other form.

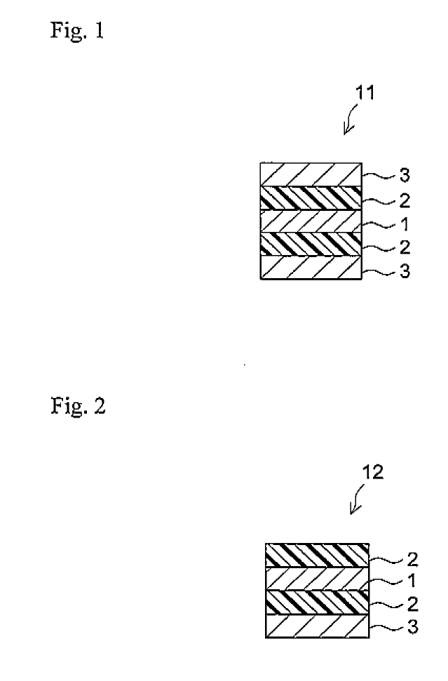

The pressure-sensitive adhesive sheet as disclosed herein may, for example, have a sectional structure schematically shown in any of FIGS. 1 to 6. Among them, each of FIGS. 1 and 2 shows a configuration example of a double-sided adhesive base-provided pressure-sensitive adhesive sheet (base-provided double-coated pressure-sensitive adhesive sheet). A pressure-sensitive adhesive sheet 11 shown in FIG. 1 has a configuration in which a pressure-sensitive adhesive layer 2 is provided on the both surfaces of a base material 1, and each of the pressure-sensitive adhesive layers 2 is protected by a release liner 3 in which at least the pressure-sensitive adhesive layer side thereof is a release surface. A pressure-sensitive adhesive sheet 12 shown in FIG. 2 has a configuration in which the pressure-sensitive adhesive layer 2 is provided on the both surfaces of the base material 1, and one of the pressure-sensitive layers 2 is protected by the release liner 3 in which the both surfaces thereof are a release surface. The pressure-sensitive adhesive sheet 12 of this kind can be constituted in such a manner that when the pressure-sensitive adhesive sheet 12 is wound, the other pressure-sensitive adhesive layer 2 comes into contact with the rear surface of the release liner 3, and the subject other pressure-sensitive adhesive layer 2 is also protected by the release liner 3.

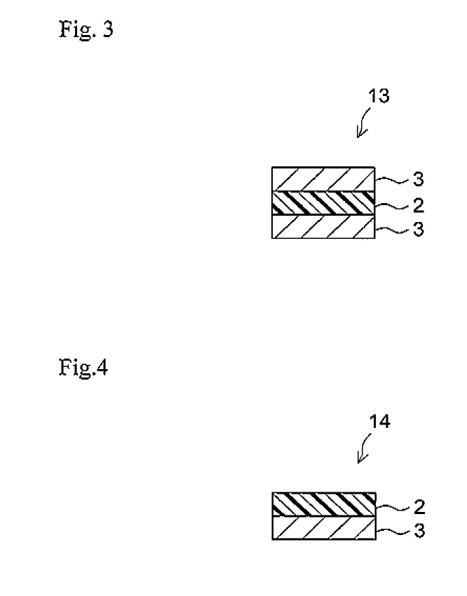

Each of FIGS. 3 and 4 shows a configuration example of a base-free pressure-sensitive adhesive sheet. A pressure-sensitive adhesive sheet 13 shown in FIG. 3 has a configuration in which each surface of the base-free pressure-sensitive adhesive layer 2 is protected by the release liner 3 in which at least the pressure-sensitive adhesive layer side thereof is a release surface. A pressure-sensitive adhesive sheet 14 shown in FIG. 4 has a configuration in which one surface of the base-free pressure-sensitive adhesive layer 2 is protected by the release liner 3 in which the both surfaces thereof are a release surface and is constituted in such a manner that when this is wound, the other surface of the pressure-sensitive adhesive layer 2 comes into contact with the rear surface of the release liner 3, and the subject other surface is also protected by the release liner 3.

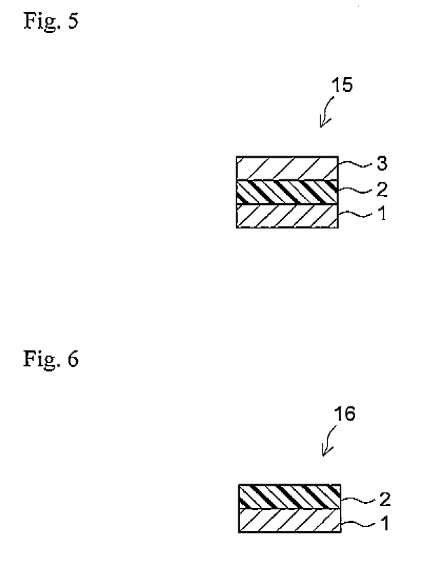

Each of FIGS. 5 and 6 shows a configuration example of a single-sided adhesive base-provided pressure-sensitive adhesive sheet. A pressure-sensitive adhesive sheet 15 shown in FIG. 5 has a configuration in which the pressure-sensitive adhesive layer 2 is provided on one surface of the base material 1, and the surface (adhesive surface) of the pressure-sensitive adhesive layer 2 is protected by the release liner 3 in which at least the pressure-sensitive adhesive layer side thereof is a release surface. A pressure-sensitive adhesive sheet 16 shown in FIG. 6 has a configuration in which the pressure-sensitive adhesive layer 2 is provided on one surface of the base material 1. The pressure-sensitive adhesive sheet 16 is constituted in such a manner that the other surface of the base material 1 is a release surface, and when the pressure-sensitive adhesive sheet 16 is wound, the pressure-sensitive adhesive layer 2 comes into contact with the subject other surface, and the surface (adhesive surface) of the pressure-sensitive adhesive layer is protected by the other surface of the base material 1.

As the base material, plastic films such as a polypropylene film, an ethylene-propylene copolymer film, a polyester film and a polyvinyl chloride film; foam base materials such as a polyurethane foam and a polyethylene foam; papers such as a craft paper, a crepe paper and a Japanese paper; cloths such as a cotton cloth and a staple fiber cloth; nonwoven fabrics such as a polyester nonwoven fabric and a vinylon nonwoven fabric; metal foils such as an aluminum foil and a copper foil; and so on can be properly chosen and used depending upon an application of the pressure-sensitive adhesive sheet. As the plastic film, any of non-oriented films and oriented (uniaxially oriented or biaxially oriented) films can be used. Also, in the base material, the surface on which the pressure-sensitive adhesive layer is provided may be subjected to a surface treatment such as coating with an undercoating agent and a corona discharge treatment. Though a thickness of the base material can be properly chosen depending on the purposes, in general, it is about 10 μm to 500 μm (typically from 10 μm to 200 μm).

The pressure-sensitive adhesive layer may be a cured layer of any of the pressure-sensitive adhesive compositions as disclosed herein. That is, the pressure-sensitive adhesive layer may be preferably formed by applying (typically coating) the pressure-sensitive adhesive composition onto an appropriate base material (which may also be a release liner) and then properly subjecting it to a curing treatment. In the case of performing two or more kinds of curing treatments (for example, drying, crosslinking, and polymerization), these treatments can be performed simultaneously or in multiple stages.

In the pressure-sensitive adhesive composition containing a partially polymerized material, typically, a final copolymerization reaction is performed as the curing treatment (the partially polymerized material is further subjected to a copolymerization reaction to form a completely polymerized material). For example, so far as a photocurable pressure-sensitive adhesive composition is concerned, irradiation with light is performed. A curing treatment such as crosslinking and drying may also be performed as the need arises. For example, in the case where the photocurable pressure-sensitive adhesive composition is required to be dried, it may be photocured after drying.

In the pressure-sensitive adhesive composition using a completely polymerized material, typically, a treatment such as drying (heat drying) and crosslinking is performed as the curing treatment as the need arises.

Coating of the pressure-sensitive adhesive composition can be, for example, performed using a customary coater such as a gravure roll coater, a reverse roll coater, a kiss roll coater, a dip roll coater, a bar coater, a knife coater and a spray coater. From the viewpoints of promotion of the crosslinking reaction, an enhancement of the production efficiency and so on, it is preferable to perform drying of the pressure-sensitive adhesive composition under heating. Though drying temperature which can be adopted varies depending upon the kind of the support onto which the composition is coated, it is for example, from about 40° C. to 150° C.

In the case of a base-provided pressure-sensitive adhesive sheet, the pressure-sensitive adhesive layer may be formed by directly applying the pressure-sensitive adhesive composition onto the base material, or the pressure-sensitive adhesive layer formed on the release liner may be transferred to the base material.

Though a thickness of the pressure-sensitive adhesive layer is not particularly limited, in general, favorable pressure-sensitive adhesive performances (for example, adhesive strength) may be realized by regulating it to about 10 μm or more (preferably about 20 μm or more, and more preferably about 30 μm or more). It is suitable that the thickness of the pressure-sensitive adhesive layer is, for example, from about 30 μm to 200 μm.

The pressure-sensitive adhesive sheet as disclosed herein may exhibit excellent high-temperature holding properties such that in a high-temperature holding strength test which is performed as described in the following Examples in conformity with JIS Z 0237, a specimen does not fall from a Bakelite plate as an adherend for at least 2 hours at any temperature of 80° C. and 100° C. Furthermore, the pressure-sensitive adhesive sheet as disclosed herein can simultaneously realize excellent low-temperature adhesiveness such that a peeling strength measured at a temperature of 5° C. in a low-temperature adhesive force test as described in the following Examples is 20 N/25 mm or more against any of an ABS plate and an acrylic plate.

### EXAMPLES

Some Examples regarding the invention are hereunder described, but it is not intended that the invention is limited to these Examples. In the following, all “parts” and “%” are on a mass standard unless otherwise indicated.

### Example 1

To 100 parts of a monomer mixture consisting of 96 parts of 2-ethylhexyl acrylate (2EHA) and 4 parts of 1-vinylimidazole (VIM), 0.05 parts of 2,2-dimethoxy-1,2-diphenylethan-1-one (trade name “Irgacure 651”, manufactured by Ciba Japan K.K.) and 0.05 parts of 1-hydroxy-cyclohexyl phenyl ketone (trade name “Irgacure 184”, manufactured by Ciba Japan K.K.) were added as photopolymerization initiators. This mixture was stirred under a nitrogen gas atmosphere, thereby thoroughly removing dissolved oxygen, and thereafter, the mixture was irradiated with ultraviolet rays to obtain a partially polymerized material of the monomer mixture (polymerization rate: 22.6%).

To this partially polymerized material, 1,6-hexanediol diacrylate (HDDA) was added as a crosslinking agent in an amount of 0.05 parts based on 100 parts of the used monomer mixture. This additive-incorporated partially polymerized material was coated on a first release liner, and a second release liner was further laminated on this coated layer. The resulting coated layer was irradiated with ultraviolet rays under a condition at an illuminance of about 5 mW/cm² in a quantity of light of about 720 mJ/cm² to form a pressure-sensitive adhesive layer having a thickness of 50 μm (gel fraction: 69%), thereby obtaining a double-coated pressure-sensitive adhesive sheet. As all of the foregoing release liners, a 38 μm-thick polyethylene terephthalate (PET) film in which the surface to be brought into contact with the pressure-sensitive adhesive layer had been subjected to a release treatment with a silicone based release agent was used.

### Example 2

A double-coated pressure-sensitive adhesive sheet was obtained in the same manner as in Example 1, except for changing the composition of the monomer mixture to a composition consisting of 92 parts of 2EHA, 4 parts of VIM and 4 parts of N-vinyl-2-pyrrolidone (NVP). A polymerization rate of the partially polymerized material was 13.2%. A gel fraction of the pressure-sensitive adhesive after curing was 64%.

### Example 3

A double-coated pressure-sensitive adhesive sheet was obtained in the same manner as in Example 1, except for changing the composition of the monomer mixture to a composition consisting of 90 parts of 2EHA and 10 parts of acrylic acid (AA) and changing the amount (an amount based on 100 parts of the monomer mixture; the same in other Examples) of HDDA to 0.04 parts. A polymerization rate of the partially polymerized material was 10%. A gel fraction of the pressure-sensitive adhesive after curing was 69.7%.

### Example 4

A double-coated pressure-sensitive adhesive sheet was obtained in the same manner as in Example 1, except for changing the composition of the monomer mixture to a composition consisting of 85 parts of 2EHA and 15 parts of VIM and changing the amount of HDDA to 0.025 parts. A polymerization rate of the partially polymerized material was 22.6%. A gel fraction of the pressure-sensitive adhesive after curing was 71.9%.

### Example 5

In a reaction vessel equipped with a cooling tube, an inlet for nitrogen gas, a thermometer, a dropping funnel and a stirrer, 85 parts of 2EHA, 15 parts of VIM and 123 parts of ethyl acetate were added, and a nitrogen gas was introduced while gently stirring, thereby purging the inside of the reaction vessel with nitrogen. This reaction solution was heated to 60° C., 0.2 parts of AIBN (polymerization initiator) was added, and the mixture was subjected to a polymerization reaction at the same temperature for 5.5 hours. Subsequently, the temperature was increased to 70° C., and the resulting mixture was further subjected to a polymerization reaction at the same temperature for 2 hours. To the obtained acrylic polymer solution, an epoxy based crosslinking agent (trade name “TETRAD-C”, manufactured by Mitsubishi Gas Chemical Company, Inc.) was added in an amount of 0.5 parts based on 100 parts of the acrylic polymer included in the solution, followed by uniformly mixing with stirring.

The resulting mixture was coated on a first release liner and then dried (cured) at 100° C. for 3 minutes to form a pressure-sensitive adhesive layer having a thickness of 50 μm. A second release liner was laminated on this pressure-sensitive adhesive layer to obtain a double-coated pressure-sensitive adhesive sheet. As all of the release liners, the same material as in Example 1 was used. A gel fraction of the pressure-sensitive adhesive after drying was 83%.

### Example 6

A double-coated pressure-sensitive adhesive sheet was obtained in the same manner as in Example 1, except for changing the composition of the monomer mixture to a composition consisting of 80 parts of 2EHA and 20 parts of VIM and changing the amount of HDDA to 0.015 parts. A polymerization rate of the partially polymerized material was 21.3%. A gel fraction of the pressure-sensitive adhesive after curing was 68.5%.

### Example 7

A double-coated pressure-sensitive adhesive sheet was obtained in the same manner as in Example 1, except for changing the composition of the monomer mixture to a composition consisting of 80 parts of 2EHA, 10 parts of VIM and 10 parts of N-acryloyl morpholine (ACMO) and changing the amount of HDDA to 0.1 parts. A polymerization rate of the partially polymerized material was 13.7%. A gel fraction of the pressure-sensitive adhesive after curing was 88%.

### Example 8

A double-coated pressure-sensitive adhesive sheet was obtained in the same manner as in Example 1, except for changing the composition of the monomer mixture to a composition consisting of 80 parts of 2EHA, 4 parts of VIM and 16 parts of NVP and changing the amount of HDDA to 0.02 parts. A polymerization rate of the partially polymerized material was about 13%. A gel fraction of the pressure-sensitive adhesive after curing was 71.3%.

### Example 9

A double-coated pressure-sensitive adhesive sheet was obtained in the same manner as in Example 1, except for changing the composition of the monomer mixture to a composition consisting of 80 parts of 2EHA and 20 parts of NVP and changing the amount of HDDA to 0.02 parts. A polymerization rate of the partially polymerized material was 13.5%. A gel fraction of the pressure-sensitive adhesive after curing was 57.7%.

### Example 10

A double-coated pressure-sensitive adhesive sheet was obtained in the same manner as in Example 1, except for changing the composition of the monomer mixture to a composition consisting of 75 parts of 2EHA and 25 parts of AA and changing the amount of HDDA to 0.04 parts. A polymerization rate of the partially polymerized material was 74%. A gel fraction of the pressure-sensitive adhesive after curing was 85.1%.

### Example 11

A double-coated pressure-sensitive adhesive sheet was obtained in the same manner as in Example 1, except for changing the composition of the monomer mixture to a composition consisting of 70 parts of 2EHA, 30 parts of NVP and 1.5 parts of AA and changing the amount of HDDA to 0.02 parts. A polymerization rate of the partially polymerized material was 12.7%. A gel fraction of the pressure-sensitive adhesive after curing was 73.0%.

### Example 12

A double-coated pressure-sensitive adhesive sheet was obtained in the same manner as in Example 1, except for changing the composition of the monomer mixture to a composition consisting of 70 parts of 2EHA and 30 parts of N,N-diethyl acrylamide (DEAA) and changing the amount of HDDA to 0.08 parts. A polymerization rate of the partially polymerized material was 11.1%. A gel fraction of the pressure-sensitive adhesive after curing was 49.0%.

### [Gel Fraction of Pressure-Sensitive Adhesive]

The gel fraction of the pressure-sensitive adhesive of each of the Examples was measured by the foregoing method. As the porous PTFE film (mass W₂), a film of its trade name “NITOFLON (registered trademark) NTF1122” (manufactured by Nitto Denko Corporation) having a size of 100 mm×100 mm was used. As the kite string (mass W₃), one having a diameter of 1.5 mm and a length of about 100 mm was used. For the pressure-sensitive adhesive sample (mass W₁), one obtained by cutting each pressure-sensitive adhesive sheet into a size of 20 cm² and peeling off the both release liners was used.

With respect to the pressure-sensitive adhesive sheets of Examples 1 to 12, the following evaluation tests were performed. The obtained results are shown in Table 1 along with the monomer composition, the use amount of crosslinking agent, the polymerization method, fg and Tg according to each of the Examples.

### [High-Temperature Holding Force]

[At 80° C.]

A holding force at 80° C. of each pressure-sensitive adhesive sheet was measured using a creep tester. That is, the first release liner of each pressure-sensitive adhesive sheet was peeled off, and a PET film having a thickness of 25 μm was stuck onto the exposed first pressure-sensitive adhesive surface. The resultant was cut into a width of 10 mm to prepare a specimen. The second release liner was peeled off from the specimen, and the exposed second pressure-sensitive adhesive surface was stuck in an adhesive area of 10 mm in width and 20 mm in length onto a Bakelite plate. The resultant was held at 80° C. for 30 minutes. Thereafter, the Bakelite plate was suspended, and a load of 500 g was applied to a free end of the specimen. The specimen was allowed to stand in a state where the load was applied under an environment at 80° C. for 2 hours in conformity with JIS Z 0237, and at a point of time after lapsing 2 hours, a deviated distance (mm) of the specimen from an original sticking position was measured.

[At 100° C.]

A holding force at 100° C. of each pressure-sensitive adhesive sheet was measured in the same manner as in the holding force at 80° C.

### [Low-Temperature Adhesive Force]

[Against Acrylic Plate]

The first release liner of each pressure-sensitive adhesive sheet was peeled off, and a PET film (not subjected to a release treatment) having a thickness of 50 μm was stuck onto the exposed first pressure-sensitive adhesive surface. The resultant was cut into a width of 25 mm to prepare a specimen, and the specimen was held under an environment at 5° C. and 50% RH for 30 minutes. The second release liner was peeled off from the specimen, followed by press bonding to an adherend by a method of pressing by a 5 kg roller one time. As the adherend, a clean acrylic plate which had been cleaned by rubbing with an isopropyl alcohol-soaked clean waste cloth 10 reciprocations. After holding this under an environment at 5° C. for 30 minutes, a peeling strength (N/25 mm) against the acrylic plate was measured using a tension tester under a condition at a tension rate of 300 mm/min and at a peeling angle of 180°.

[Against ABS Plate]

A peeling strength (N/25 mm) against an ABS plate was measured using an ABS plate cleaned in the same manner as above in place of the acrylic plate.

TABLE 1

| | | | | | | | | | | | | Low-Temperature | |
|---|---|---|---|---|---|---|---|---|---|---|---|---|---|
| | | | | | | | | | | High-Temperature | | Adhesive Force | |
| | | | | | | | Cross- | | | Holding Force | | Peeling Strength | |
| | | | | | | | linking | Polymer- | | Deviated | | at 5° C. (N/25 mm) | |
| | Monomer Composition (parts) | | | | | | Agent | ization | fg | Distance (mm) | | ABS | Acrylic |
| Example | 2EHA | VIM | NVP | ACMO | DEAA | AA | (parts) | Method | (%) | 80° C. | 100° C. | Plate | Plate |
| 1 | 96 | 4 | — | — | — | — | 0.05 | UV | 69 | Fallen | Fallen | 12.9 | 14.7 |
| 2 | 92 | 4 | 4 | — | — | — | 0.05 | UV | 64 | Fallen | Fallen | 12.4 | 13.8 |
| 3 | 90 | — | — | — | — | 10 | 0.04 | UV | 69.7 | 7.2 | Fallen | 7.2 | 7.6 |
| 4 | 85 | 15 | — | — | — | — | 0.025 | UV | 71.9 | 0.2 | 0.1 | 22.5 | 22.2 |
| 5 | 85 | 15 | — | — | — | — | 0.5 | Solution | 83 | 0.1 | 0.1 | 20.1 | 21.3 |
| 6 | 80 | 20 | — | — | — | — | 0.015 | UV | 68.5 | 0.1 | 0.1 | 23.0 | 22.9 |
| 7 | 80 | 10 | — | 10 | — | — | 0.1 | UV | 88 | 0.1 | 0.2 | 24.8 | 20.0 |
| 8 | 80 | 4 | 16 | — | — | — | 0.02 | UV | 71.3 | 0.1 | 0.1 | 24.2 | 22.8 |
| 9 | 80 | — | 20 | — | — | — | 0.02 | UV | 57.7 | 0.2 | Fallen | 23.3 | 21.6 |
| 10 | 75 | — | — | — | — | 25 | 0.04 | UV | 85.1 | 0.1 | 0.1 | 0.1 | 0.1 |
| 11 | 70 | — | 30 | — | — | 1.5 | 0.02 | UV | 73 | 0.1 | 0.18 | 16 | 22 |
| 12 | 70 | — | — | — | 30 | — | 0.08 | UV | 49 | Fallen | Fallen | 24 | 26.3 |

As shown in Table 1, all of the pressure-sensitive adhesive sheets of Examples 4 to 6 composed of, in addition to the monomer m1 as a main component, a sufficient amount of the monomer m2 (VIM), realized both excellent high-temperature holding force and low-temperature adhesive force at the same time such that the deviated distance in the holding force test at each of 80° C. and 100° C. was not more than 0.2 mm and that the peeling strength was 20 N/25 mm or more. Also, similar to the pressure-sensitive adhesive sheets of Examples 4 to 6, all of the pressure-sensitive adhesive sheets of Examples 7 and 8, in which even when the use amount of the monomer m2 was less than 12%, a sufficient amount of the monomer m3 was used, exhibited excellent high-temperature holding force and low-temperature adhesive force. Furthermore, as demonstrated by the results of Examples 4 and 5, in the case of using a monomer mixture having the same composition, even when the polymerization method of the mixture was different, the pressure-sensitive adhesive sheets exhibiting excellent high-temperature holding properties and low-temperature adhesiveness were formed.

On the other hand, all of the pressure-sensitive adhesive sheets of Examples 1 and 2 in which the use amount of the monomer m2, or the total use amount of the monomers m2 and m3, was small; Examples 9, 11 and 12 in which the monomer m2 was note used, and the monomer m3 was used; and Examples 3 and 10 in which neither the monomer m2 nor the monomer m3 was used, were insufficient in at least one of the high-temperature holding force and the low-temperature adhesive force.

While the invention has been described in detail with reference to specific embodiments thereof, these are merely exemplifications and do not limit the scope of the claims. The technologies described in the scope of the claims include various modifications and changes of the specific embodiments as exemplified above.

The present application is based on the Japanese Patent Application No. 2009-294490 filed on Dec. 25, 2009, and the contents thereof are incorporated herein by reference.

What is claimed is:

1. An acrylic pressure-sensitive adhesive composition comprising a copolymerization reaction product of a monomer mixture satisfying the following both conditions:
(a) the monomer mixture includes a monomer m1 in an amount of 50% by mass or more based on whole monomer components constituting the monomer mixture,
wherein the monomer m1 is an alkyl (meth)acrylate represented by the following formula (I):
CH₂═C(R¹)COOR² (I)
wherein R¹ represents a hydrogen atom or a methyl group, and R² represents an alkyl group having from 1 to 20 carbon atoms; and
(b) the monomer mixture includes a monomer m2 in an amount of 12% by mass or more based on the whole monomer components constituting the monomer mixture, or a monomer m2 and a monomer m3 in an amount in total of 12% by mass or more based on the whole monomer components constituting the monomer mixture,
wherein the monomer m2 is an imidazole group-containing unsaturated monomer, and
the monomer m3 is an amide group-containing unsaturated monomer.

2. The pressure-sensitive adhesive composition according to claim 1, wherein the monomer mixture includes the monomer m2 in an amount of 12% by mass or more based on the whole monomer components constituting the monomer mixture.

3. The pressure-sensitive adhesive composition according to claim 1, wherein the monomer mixture includes the monomer m3 in an amount of 0.1% by mass or more based on the whole monomer components constituting the monomer mixture.

4. The pressure-sensitive adhesive composition according to claim 1, wherein the monomer m2 is 1-vinylimidazole.

5. The pressure-sensitive adhesive composition according to claim 1, wherein the monomer m3 is an N-vinyl cyclic amide compound represented by the following formula (II): 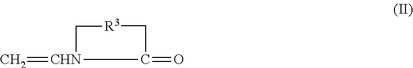
wherein R³ represents a divalent organic group having a number of atoms included in a lactam ring of from 3 to 5.

6. The pressure-sensitive adhesive composition according to claim 5, wherein the N-vinyl cyclic amide compound is N-vinyl-2-pyrrolidone.

7. The pressure-sensitive adhesive composition according to claim 1, wherein a blending ratio of the monomer m2 to the monomer m3 is from 10/1 to 1/10.

8. The pressure-sensitive adhesive composition according to claim 1, which further comprises a crosslinking agent.

9. A pressure-sensitive adhesive sheet comprising a pressure-sensitive adhesive layer formed of the pressure-sensitive adhesive composition according to claim 1.

10. A pressure-sensitive adhesive sheet comprising a pressure-sensitive adhesive layer formed of the pressure-sensitive adhesive composition according to claim 4.

11. A pressure-sensitive adhesive sheet comprising a pressure-sensitive adhesive layer formed of the pressure-sensitive adhesive composition according to claim 6.

12. A method for producing a pressure-sensitive adhesive sheet, the method comprising:
(X) subjecting a monomer mixture to a copolymerization reaction to prepare a pressure-sensitive adhesive composition, wherein the monomer mixture satisfying the following both conditions:
(a) the monomer mixture includes a monomer m1 in an amount of 50% by mass or more based on the whole monomer components constituting the monomer mixture,
wherein the monomer m1 is an alkyl (meth)acrylate represented by the following formula (I):
CH₂═C(R¹)COOR² (I)
wherein R¹ represents a hydrogen atom or a methyl group, and R² represents an alkyl group having from 1 to 20 carbon atoms; and
(b) the monomer mixture includes a monomer m2 in an amount of 12% by mass or more based on the whole monomer components constituting the monomer mixture, or a monomer m2 and a monomer m3 in an amount in total of 12% by mass or more based on the whole monomer components constituting the monomer mixture,
wherein the monomer m2 is an imidazole group-containing unsaturated monomer, and
the monomer m3 is an amide group-containing unsaturated monomer;
(Y) applying the pressure-sensitive adhesive composition on a base material; and
(Z) curing the coated pressure-sensitive adhesive composition to form a pressure-sensitive adhesive layer.
